(19) United States
(12) Patent Application Publication
(10) Pub. No.: US 2015/0083557 A1
(43) Pub. Date: Mar. 26, 2015

(54) WATER TANK WITH A MAGNETIC REED SWITCH

(71) Applicant: New Widetech Industries Co., Ltd., New Taipei City (TW)

(72) Inventor: Ming-Tsung Chiu, New Taipei City (TW)

(73) Assignee: New Widetech Industries Co., Ltd., New Taipei City (TW)

(21) Appl. No.: 14/037,884

(22) Filed: Sep. 26, 2013

(51) Int. Cl. H01H 36/00; H01H 36/02

(52) U.S. Cl. CPC H01H 36/0046; H01H 36/02
USPC 200/61.2

(57) ABSTRACT

A water tank is mounted in a household appliance and has a shell, a container, a float and a magnetic reed switch. The container is mounted slidably in the shell. The float is mounted pivotally in the container and has an actuating rod. The magnetic reed switch is mounted securely on the outside wall of the shell and corresponds to and separates from the actuating rod. Since the actuating rod utilizes magnetic force to switch the magnetic reed switch on and off, the actuating rod and the magnetic reed switch need no abutting structures. Therefore, when the actuating rod is pivoted by an accidental force, the actuating rod self-pivots back to the original position once the accidental force is removed. Then the magnetic reed switch is switched on again so that the household appliance is restarted without extra acts by a user.

### BACKGROUND OF THE INVENTION

1. Field of the Invention

The present invention relates to a water tank, especially to a water tank for household appliances.

2. Description of the Prior Arts

Some household appliances such as dehumidifiers have water tanks to collect water. When the household appliance is operated, the moist air is drawn into the household appliance. Then the moist air is transformed into water and is collected in the water tank. When the water tank collects a certain amount of water, the household appliance stops operating until the user empties the water tank.

With reference to FIGS. 10 and 11, to stop the household appliance via change of the water level, a conventional water tank comprises a shell 50, a container 60, a float 70 and a micro switch 80. The container 60 is mounted slidably in the shell 50. The float 70 is mounted pivotally in the top of the container 60. The float 70 has an actuating rod 701 extending from one side thereof. The actuating rod 701 protrudes through the container 60. The micro switch 80 is mounted out of the shell 50 and has a pivoting lever 801. The pivoting lever 801 corresponds to the actuating rod 701.

In a normal status, the float 70 is positioned horizontally and the actuating rod 701 presses against the lever 801 such that the micro switch 80 is switched on and the household appliance is operated. Then water is collected continuously in the container 60.

When the collected water in the container 60 is gradually increased, the water lever raises to pivot the float 70 until the actuating rod 701 leaves the lever 801. The lever 801 is pivoted toward the container 60 and the actuating rod 701 abuts between the bottom of the lever 801 and the sidewall of the container 60. Then an open circuit is formed and the household appliance is stopped from operating and the water stops from flowing into the container 60. The user needs to pull the container 60 out of the shell 50 to empty the water inside so that the float 70 is allowed to pivot back to the horizontal status. Then the container 60 is pushed back into the shell 50 so that the actuating rod 701 presses the lever 801 again. The micro switch 80 is then on and the household appliance is restarted.

However, since the actuating rod 701 abuts between the bottom of the lever 801 and the sidewall of the container 60 when the float 70 is pivoted, if the float 70 is accidentally pivoted because the household appliance is placed upside down or is vibrated, the float 70 cannot self-pivot back to the original position. Even if the container 60 has no water inside, the actuating rod 701 may abut against the bottom of the lever 801 and cannot press the lever 801 to actuate the micro switch 80. Therefore, the user needs to pull out and push back the container 60 to restart the household appliance regardless that the container 60 is full or not.

To overcome the shortcomings, the present invention provides a water tank with a magnetic reed switch to mitigate or obviate the aforementioned problems.

### SUMMARY OF THE INVENTION

The main objective of the present invention is to provide a water tank with a magnetic reed switch. The water tank is mounted in a household appliance and has a shell, a container, a float and a magnetic reed switch. The container is mounted slidably in the shell. The float is mounted pivotally in the container and has an actuating rod. The magnetic reed switch is mounted securely on the outside wall of the shell and corresponds to and separates from the actuating rod. Since the actuating rod utilizes magnetic force to switch the magnetic reed switch on and off, the actuating rod and the magnetic reed switch need no abutting structures. Therefore, when the actuating rod is pivoted by an accidental force, the actuating rod self-pivots back to its original position once the accidental force is removed. Then the magnetic reed switch is switched on again so that the household appliance is restarted without any extra acts by a user.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a water tank in accordance with the present invention;

FIG. 2 is another perspective view of the water tank in FIG. 1;

FIG. 3 is a partially exploded perspective view of the water tank in FIG. 1; in FIG. 1;

FIG. 5 is an exploded perspective view of a magnetic reed switch of the water tank in FIG. 1;

FIG. 6 is an operational side view in partial section of the water tank in FIG. 1, showing a closed circuit;

FIG. 7 is an enlarged operational side view in partial section of the water tank in FIG. 1, showing a closed circuit;

FIG. 8 is an operational side view in partial section of the water tank in FIG. 1, showing an open circuit;

FIG. 9 is an enlarged operational side view in partial section of the water tank in FIG. 1, showing an open circuit;

FIG. 10 is an operational side view in partial section of a conventional water tank in accordance with the prior art, showing a closed circuit; and

FIG. 11 is an operational side view in partial section of the conventional water tank in FIG. 10, showing an open circuit.

### DETAILED DESCRIPTION OF THE PREFERRED EMBODIMENTS

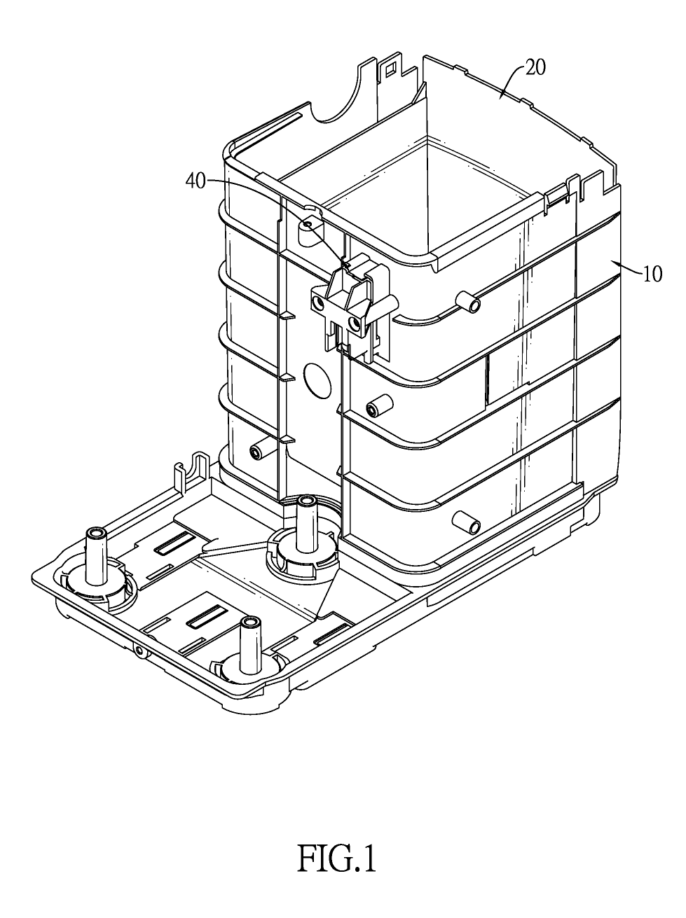

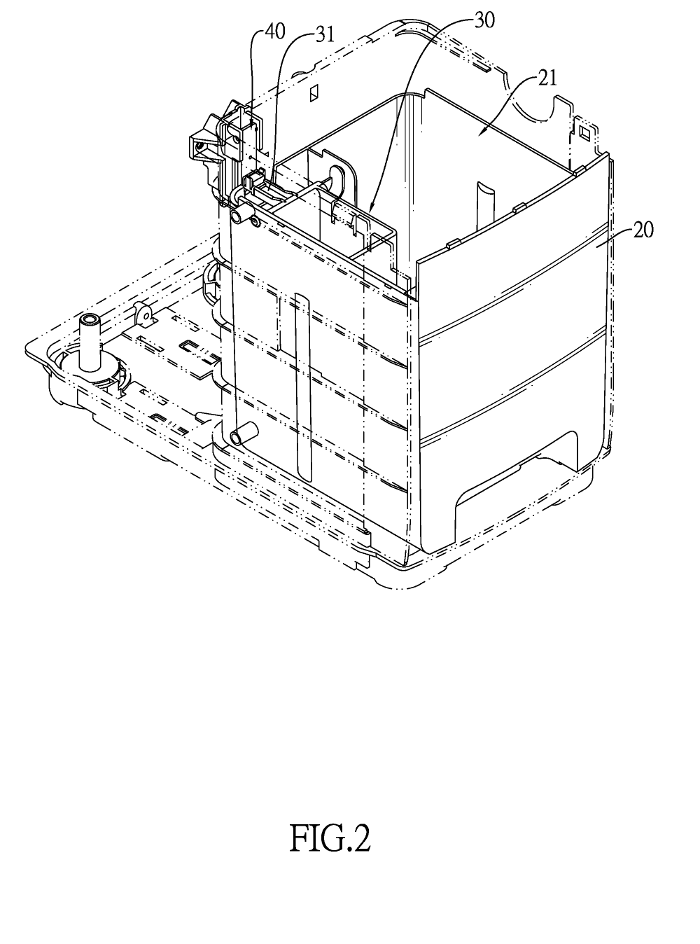

With reference to FIGS. 1 and 2, a water tank in accordance with the present invention is mounted in a household appliance and comprises a shell 10, a container 20, a float 30 and a magnetic reed switch 40.

With reference to FIGS. 2, 3 and 6, the shell 10 is hollow and has an opening 11 formed through a side thereof and a gap 12 formed through an opposite side thereof.

The container 20 is hollow, is mounted slidably in the opening 11 of the shell 10 and has an opening 21 and a gap 22. The opening 21 of the container 20 is formed through a top of the container 20. The gap 22 of the container 20 is formed through a side of the container 20 and communicates with the gap 12 of the shell 10.

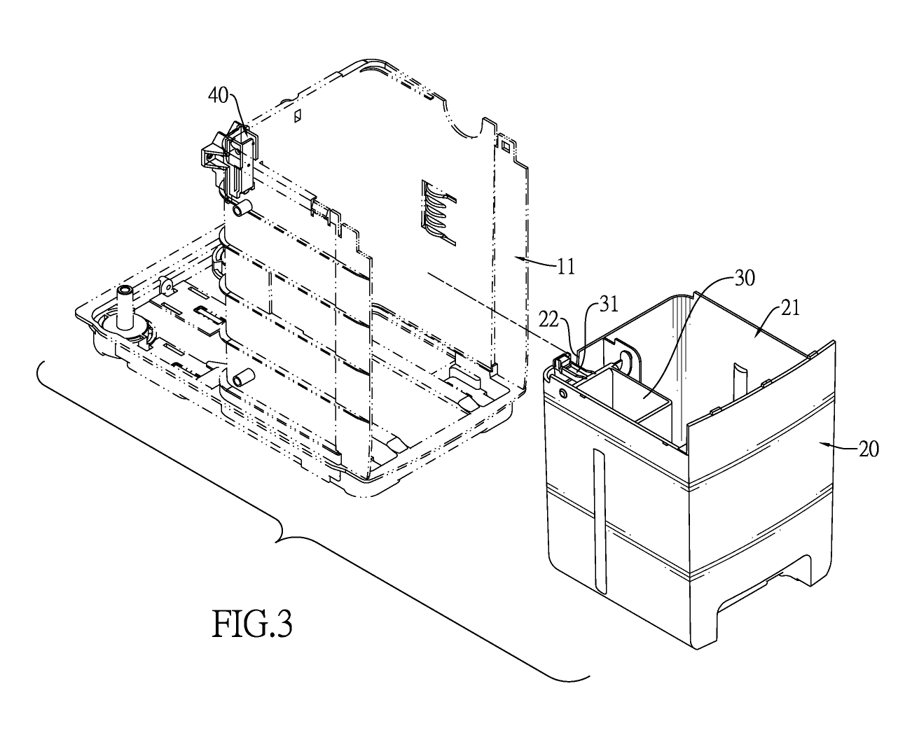

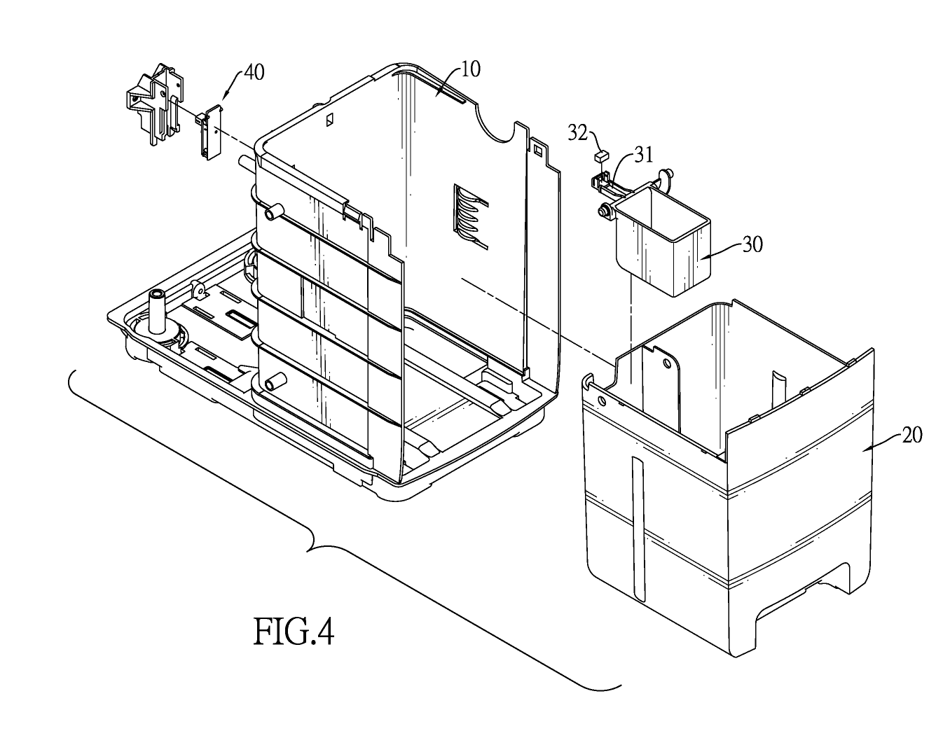

With reference to FIGS. 3 and 4, the float 30 is mounted pivotally on a sidewall of the container 20 near the top of the container 20 and has an actuating rod 31 and a magnet 32. The actuating rod 31 extends from a side of the float 30 and is mounted through the gap 22 of the container 20 and the gap 12 of the shell 10. The magnet 32 is mounted securely on an end of the actuating rod 31.

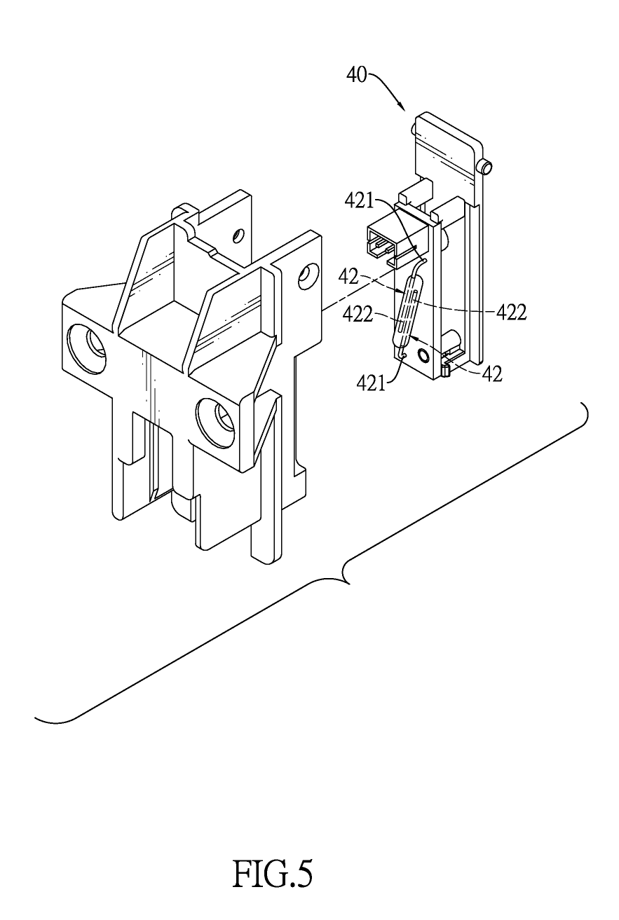

With reference to FIGS. 4 and 5, the magnetic reed switch 40 is mounted on an outside wall of the shell 10 and corresponds to the end of the actuating rod 31. The magnetic reed switch 40 and the actuating rod 31 separate from each other. The magnetic reed switch 40 has a tube 41 mounted on the outside wall of the shell 10 and two magnetic reeds 42. Each magnetic reed 42 is mounted through the tube 41 and has an outer end 421 and an inner end 422. The outer ends 421 of the magnetic reeds 42 protrude out of the tube 41 and connect electrically to a circuit. The inner ends 422 of the magnetic reeds 42 are mounted in the tube 41 and are adjacent to each other.

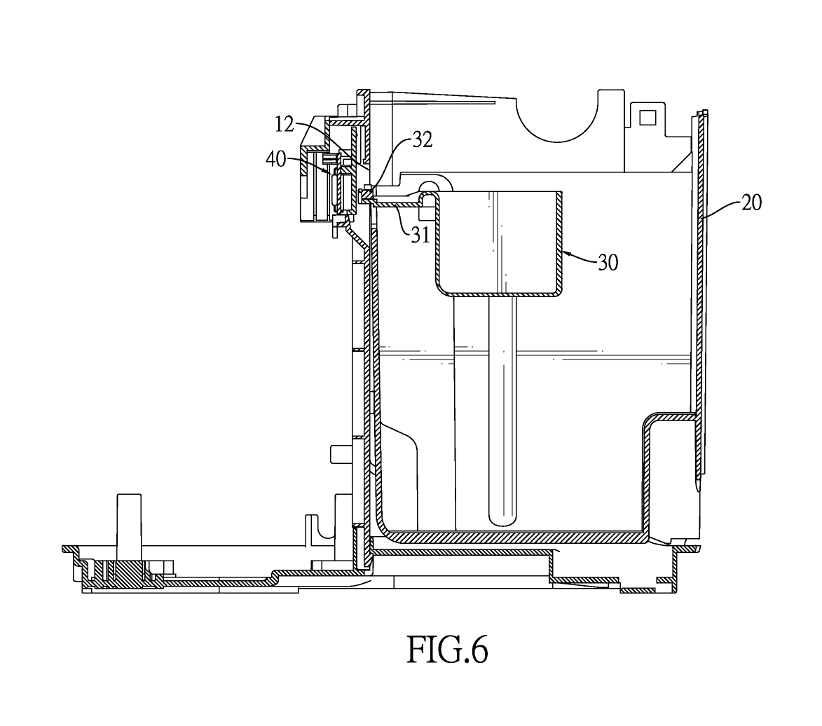

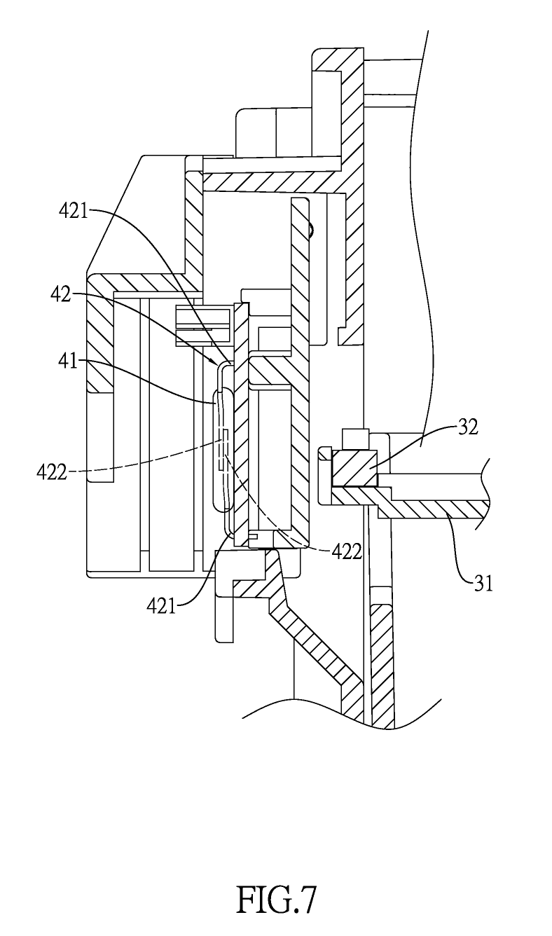

With reference to FIGS. 6 and 7, in a normal status, the float 30 is positioned horizontally and the magnet 32 on the actuating rod 31 aligns with the inner ends 422 of the magnetic reeds 42. Through the magnetic field generated by the magnet 32, the inner ends 422 of the magnetic reeds 42 resist the magnetic reeds' own resilience and deform, such that the inner ends 422 of the magnetic reeds 422 are forced to abut each other. Therefore, the household appliance is operated.

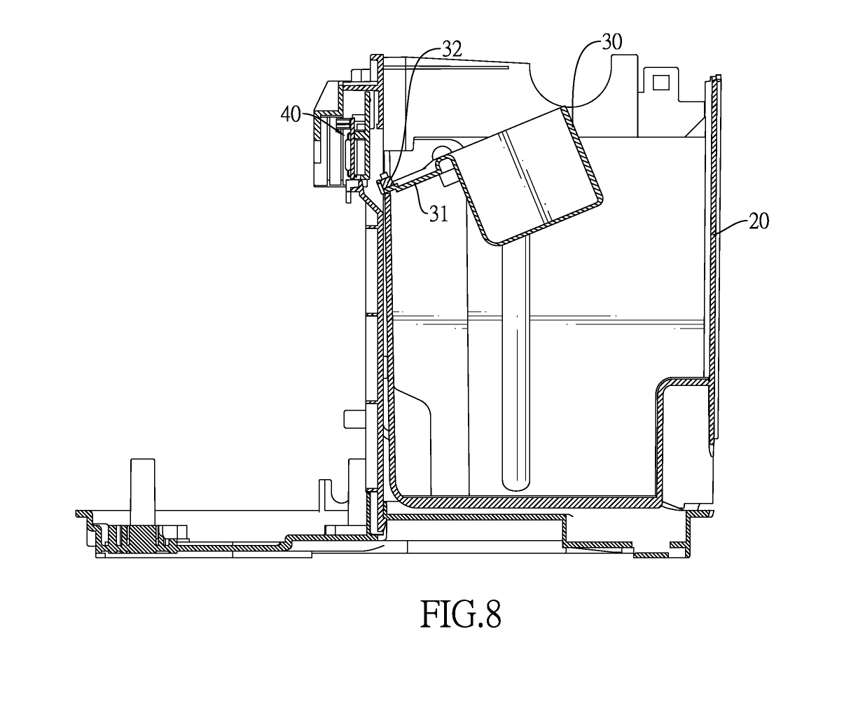

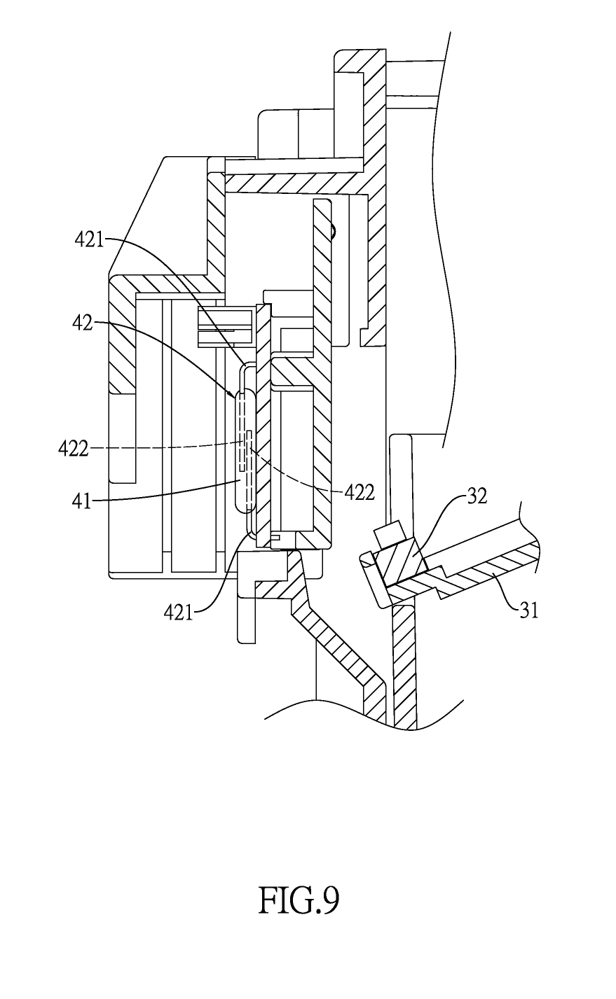

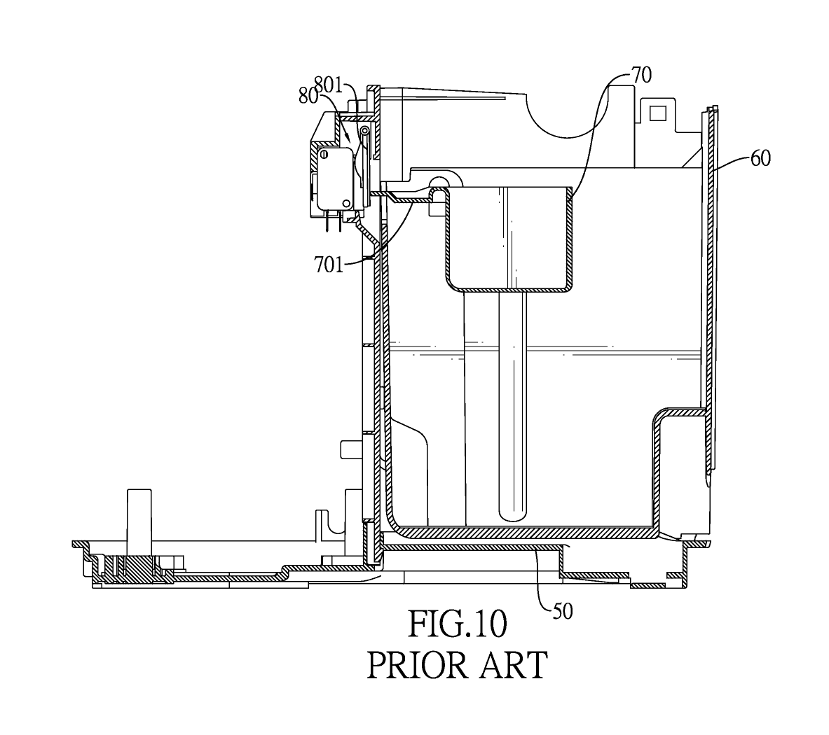

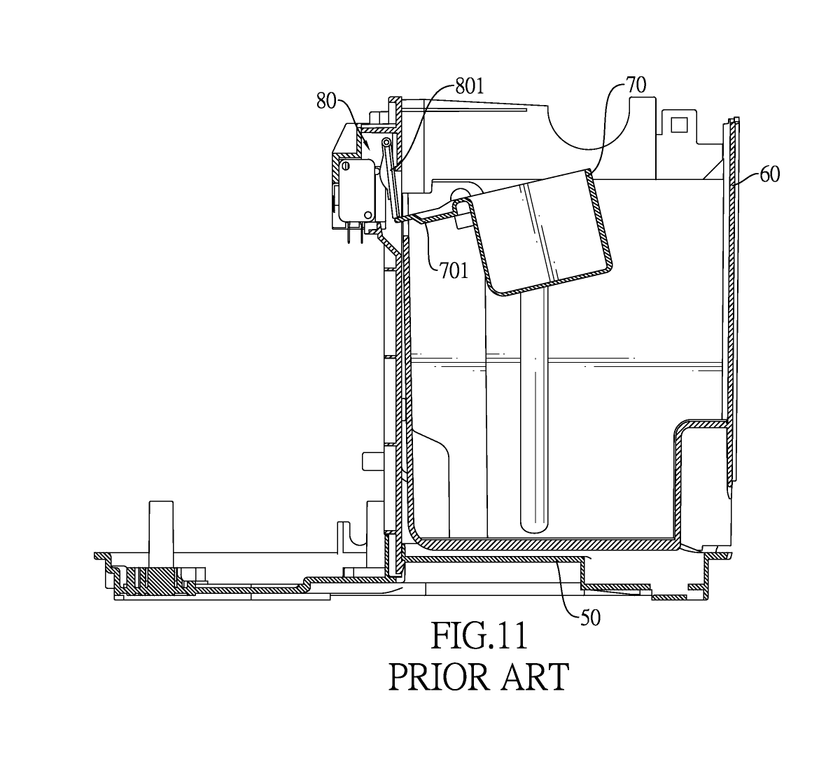

With reference to FIGS. 8 and 9, the collected water in the container 20 reaches a threshold water level to pivot the float 30 such that the magnet 32 on the actuating rod 31 misaligns with the inner ends 422 of the magnetic reeds 42. Without the magnetic force, the inner ends 422 of the magnetic reeds 42 depart from each other by the resilient force of the magnetic reeds 42. Then the open circuit is formed and the household appliance is stopped from operating.

Since on-and-off of the magnetic reed switch 40 is changed by the alignment between the magnet 32 on the actuating rod 31 and the inner ends 422 of the magnetic reeds 42, the magnetic reed switch 40 and the actuating rod 31 do not have to contact or abut against each other. Therefore, if the household appliance is accidentally moved or positioned upside down to pivot the float 30 and the magnet 32 on the actuating rod 31 misaligns with the inner ends 422 of the magnetic reeds 42, the magnet 32 on the actuating rod 31 can always re-align with the inner ends 422 of the magnetic reeds 42 once the household appliance is reinstated to the original position. Therefore, the magnetic reed switch 40 is automatically on again and the household appliance is restarted without any extra acts by the user.

Moreover, since the magnetic reed switch 40 is mounted securely on the outside wall of the shell 10 and needs no other pivoting structures, the structures of the water tank as described are simplified.

Even though numerous characteristics and advantages of the present invention have been set forth in the foregoing description, together with details of the structure and features of the invention, the disclosure is illustrative only.

Changes may be made in the details, especially in matters of shape, size, and arrangement of parts within the principles of the invention to the full extent indicated by the broad general meaning of the terms in which the appended claims are expressed.

What is claimed is:

1. A water tank comprising:
a hollow shell;
a hollow container mounted slidably in the shell;
a float mounted pivotally on a sidewall of the container and having
an actuating rod extending from a side of the float; and
a magnet mounted securely on the actuating rod;
a magnetic reed switch mounted on an outside wall of the shell, separating from the actuating rod and having
a tube mounted on the outside wall of the shell; and
two magnetic reeds, and each magnetic reed mounted through the tube and having an outer end and an inner end, wherein the outer ends of the magnetic reeds protrude out of the tube and the inner ends of the magnetic reeds are mounted in the tube and are adjacent to each other.

2. The water tank as claimed in claim 1, wherein
the magnet is mounted on an end of the actuating rod; and
the magnetic reed switch is mounted corresponding to the end of the actuating rod.

3. The water tank as claimed in claim 1, wherein
the shell has a gap formed through a side of the shell;
the container has a gap formed through a side of the container and communicating with the gap of the shell; and
the actuating rod is mounted through the gap of the container and the gap of the shell.

4. The water tank as claimed in claim 2, wherein
the shell has a gap formed through a side of the shell;
the container has a gap formed through a side of the container and communicating with the gap of the shell; and
the actuating rod is mounted through the gap of the container and the gap of the shell.

5. The water tank as claimed in claim 1, wherein
the shell has an opening formed through a side of the shell; and
the container is mounted slidably in the opening of the shell.

6. The water tank as claimed in claim 2, wherein
the shell has an opening formed through a side of the shell; and
the container is mounted slidably in the opening of the shell.

7. The water tank as claimed in claim 3, wherein
the shell has an opening formed through a side opposite to the side formed with the gap of the shell; and
the container is mounted slidably in the opening of the shell.

8. The water tank as claimed in claim 4, wherein
the shell has an opening formed through a side opposite to the side formed with the gap of the shell; and
the container is mounted slidably in the opening of the shell.

9. The water tank as claimed in claim 1, wherein the float is mounted near a top of the container.

10. The water tank as claimed in claim 2, wherein the float is mounted near a top of the container.

11. The water tank as claimed in claim 3, wherein the float is mounted near a top of the container.

12. The water tank as claimed in claim 4, wherein the float is mounted near a top of the container.

13. The water tank as claimed in claim 5, wherein the float is mounted near a top of the container.

14. The water tank as claimed in claim 6, wherein the float is mounted near a top of the container.

15. The water tank as claimed in claim 7, wherein the float is mounted near a top of the container.

16. The water tank as claimed in claim 8, wherein the float is mounted near a top of the container.
